(19) United States
(12) Patent Application Publication
(10) Pub. No.: US 2019/0370439 A1
(43) Pub. Date: Dec. 5, 2019

(54) SECURE SYSTEM ON CHIP FOR PROTECTING SOFTWARE PROGRAM FROM TAMPERING, REHOSTING AND PIRACY AND METHOD FOR OPERATING THE SAME

(71) Applicant: SunASIC Technologies, Inc., New Taipei City (TW)

(72) Inventors: Chi Chou LIN, New Taipei City (TW); Zheng Ping HE, New Taipei City (TW)

(21) Appl. No.: 15/990,987

(22) Filed: May 29, 2018

(51) Int. Cl. G06F 21/12; G06F 12/14; G06F 13/28; G06F 21/62; G06F 21/64

(52) U.S. Cl. CPC G06F 21/12; G06F 12/1458; G06F 2212/1052; G06F 21/6209; G06F 21/64; G06F 13/28

(57) ABSTRACT

A secure system on chip that prevents a software program from being tampered, rehosted, and pirated is disclosed. The secure system on chip includes: a processor; a memory unit, wherein at least a portion thereof is configured into a protected memory area by limiting the read, write, and/or execute right thereof; a memory protection unit (MPU), connected between the processor and the memory unit, for managing access of the memory unit from the processor; and a memory signature unit, connected to the processor and the memory unit, having a read-only register stored with a memory signature extracted from contents stored in a specified memory area of the memory unit by a signature extraction signal received from the processor, wherein the memory signature unit is connected to the memory unit via a Direct Memory Access (DMA) channel.

### FIELD OF THE INVENTION

The present invention relates to a secure System on Chip (SoC) and a method for operating the SoC. More particularly, the present invention relates to a secure SoC for protecting software program from tampering, rehosting and piracy and a method for operating the SoC.

### BACKGROUND OF THE INVENTION

In a computer or microprocessor environment, memory protection is usually realized through memory management unit (MMU), or sometimes called paged memory management unit (PMMU), which is a hardware unit having all memory access passed through itself and performing the translation of virtual memory addresses to physical addresses. Through MMU, running programs are isolated by given separate working space, which prevents the program from accessing memory that is not allocated to it.

Due to the complexity and cost of the MMU hardware, the memory protection function is usually not available in low-cost microprocessor devices. For most of the embedded systems, this is usually not a problem because all the codes and data are confined in a closed system. However, when Internet of Things (IoT) products are widespread, an embedded product may be required to run downloaded APPs, or receive software updates from remote servers. The security issue now becomes a major concern. Most of the technical security issues of IoT devices are similar to those of conventional servers, personal computers and smartphones, but the firewall, security update and anti-malware systems used for those are generally unsuitable for the much small and less capable IoT devices. This problem is particularly real due to the fact that most low-cost systems are von Neumann architecture, in which instruction and data resides in a common memory space and are accessed through a common bus.

Other than the complex hardware MMU, various low-cost techniques can be deployed in low-cost systems to improve security. For example, the execute-only memory (XOM) technique, which can be used to prevent program code from being exploited by malicious codes from outside.

U.S. Pat. No. 8,327,100 discloses an implementation of execute-only memory (XOM) by allowing data in the protected memory space to be accessed by codes that reside in the same protected memory space. This approach comes at the cost of increased complexity of the processor execution pipeline, because each data memory access request must be matched against the address of the corresponding retired instruction fetch.

The present invention proposes an alternative, simplified way to guarantee a memory space declared as execute-only memory (XOM) to be consistent and unaltered, while its content is unavailable to program access. This approach is particularly attractive when crypto-accelerator hardware is available in the SoC system.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

According to an aspect of the present invention, a secure system on chip that prevents a software program from being tampered, rehosted, and pirated is disclosed. The secure system on chip includes: a processor; a memory unit, wherein at least a portion thereof is configured into a protected memory area by limiting the read, write, and/or execute right thereof, and instructions of the software program to be protected are stored in a protected memory area defined as execute-only to forbid any non-instruction fetch access from the processor; a memory protection unit (MPU), connected between the processor and the memory unit, for managing access of the memory unit from the processor, wherein the MPU distinguishes instruction fetch access from other type access of the memory unit; and a memory signature unit, connected to the processor and the memory unit, having a read-only register to store a memory signature value extracted from contents stored in a specified memory area of the memory unit by a signature extraction signal received from the processor, wherein the memory signature unit is connected to the memory unit via a Direct Memory Access (DMA) channel. A signature value stored in the memory signature unit is compared with a predetermined signature data to verify the validity of the protected software program.

According to the present invention, a signature value may be a hash value or a checksum of the contents stored in a specified memory area. The execute-only memory area may be defined according to a start address and a length, or a memory range as a pair of start and end addresses of the execute-only memory area. The memory protection unit may manage access of the memory unit from the processor according to the range of the protected memory area and the attribute thereof. Multiple program segments can be stored in different protected memory areas of the memory unit, while each program segment comprises multiple instructions. The secure system on chip may comprise other co-processor(s) or I/O device(s), and accesses of the memory unit from other co-processor(s) or I/O device(s) are managed by the MPU. The signature extraction signal may comprise a start address and a length, or a memory range as a pair of start and end addresses of the memory area, and optionally an activation signal to invoke the memory signature unit.

The present invention also discloses a method to manage the access of the memory unit of the secure system on chip mentioned above. The method includes the steps of: a) a memory access is initiated; b) determining whether a memory access is from the memory signature unit; c) if an answer of step b) is no, allowing memory access if the memory address to be accessed is not within an execute-only memory area, allowing instruction fetch access if the memory address to be accessed is within an execute-only memory area, or aborting memory access if the memory address to be accessed is within an execute-only memory area and memory access is data (read or write) access; and if an answer of step b) is yes, the memory access is allowed when the memory address to be accessed is within a valid memory area. The present invention also discloses a method to verify the validity of the protected software program stored in the execute-only memory areas of the memory unit. The method includes the steps of: a) generating a signature value of a specified memory area by the memory signature unit, storing the signature value into a read-only register in the memory signature unit; and b) comparing the signature value stored in the memory signature unit with a predetermined signature data.

### BRIEF DESCRIPTION OF THE DRAWINGS

FIG. 1 shows a block diagram of an example secure system on chip.

FIG. 2 shows the access right of a normal memory area and an execute-only memory area of the present invention.

FIG. 3 shows an example memory map having an execute-only memory area.

FIG. 4 shows a flowchart of an example method to allow or forbid access to the memory unit having execute-only memory areas.

### DETAILED DESCRIPTION OF THE PREFERRED EMBODIMENTS

The present invention will now be described more specifically with reference to the following embodiments.

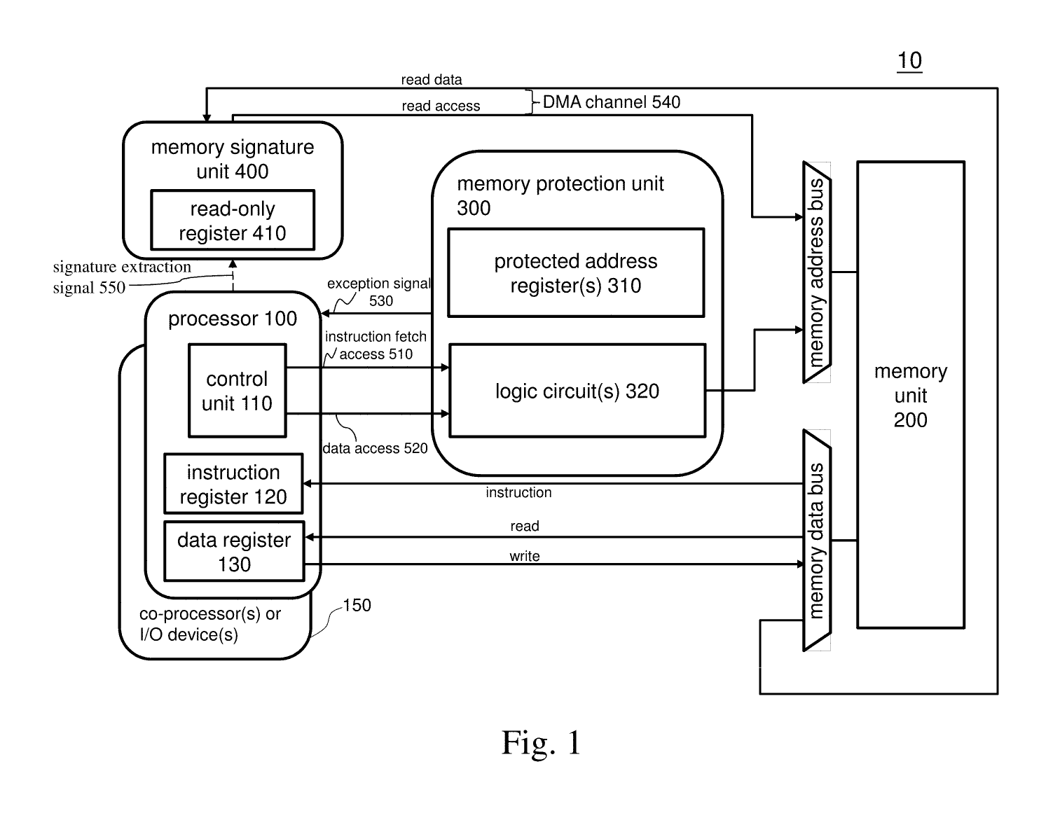

Please refer to FIG. 1. FIG. 1 shows a block diagram of an example secure System on Chip (SoC) 10. The SoC 10 can protect a software program from tampering, rehosting, and piracy. The secure SoC 10 contains a processor 100, a memory unit 200, a Memory Protection Unit (MPU) 300, and a memory signature unit 400. The processor 100 contains a control unit 110, an instruction register 120, and a data register 130. Other important units, such as Arithmetic Logic Unit (ALU), Floating-Point Unit (FPU), instruction pipeline, that are not directly related to the present invention are not shown. For example, the processor 100 can be a microprocessor having a von Neumann architecture with a single data bus to access instructions and data in a common memory space. One or more access rights can be assigned to locations in the memory unit 200. For example, typical MPUs include a read-only access right to prevent code corruption, e.g., by aborting attempts to write to a read-only protected area of the memory unit 200. In some implementations, the MPU 300 can assign one or more memory areas of a memory map (not shown) as execute-only memory areas in the memory unit 200, which will be described in further detail below.

The memory unit 200 is an array of memory cells, where instructions of software program and data are stored. The processor 100 can perform functions of software program by fetching instructions from the memory unit 200. The types of instruction may include memory read/write operations, arithmetic and logic operations, control flow operations, and coprocessor instructions. For example, memory operating instructions can instruct the processor 100 to access the memory unit 200 to read data from or write data to a specific memory location. Based on the access right assigned to the memory location, the memory access can be allowed or forbidden. The MPU 300 can prevent the processor 100 from reading data from or writing data to a memory address in a protected area based on a memory access type and the memory location in the memory unit 200.

The processor 100 can access (e.g., read, write, or execute) the stored instructions or data in the memory unit 200 by sending control signals to the memory unit 200. The control unit 110 then decodes each individual instruction into several sequential steps (e.g., fetching addresses or data from registers or memory, managing execution, and storing the resulting data back into registers or memory) that control inner works of the processor 100. The control unit 110 sends signals (through MPU300) to the memory unit 200 to specify a memory address and a memory operation, such as an instruction fetch, a read data memory access, or a write data memory access. For example, while the processor 100 specifies a memory address in a read data memory access, the memory unit 200 may return the data stored at that memory address to the processor 100.

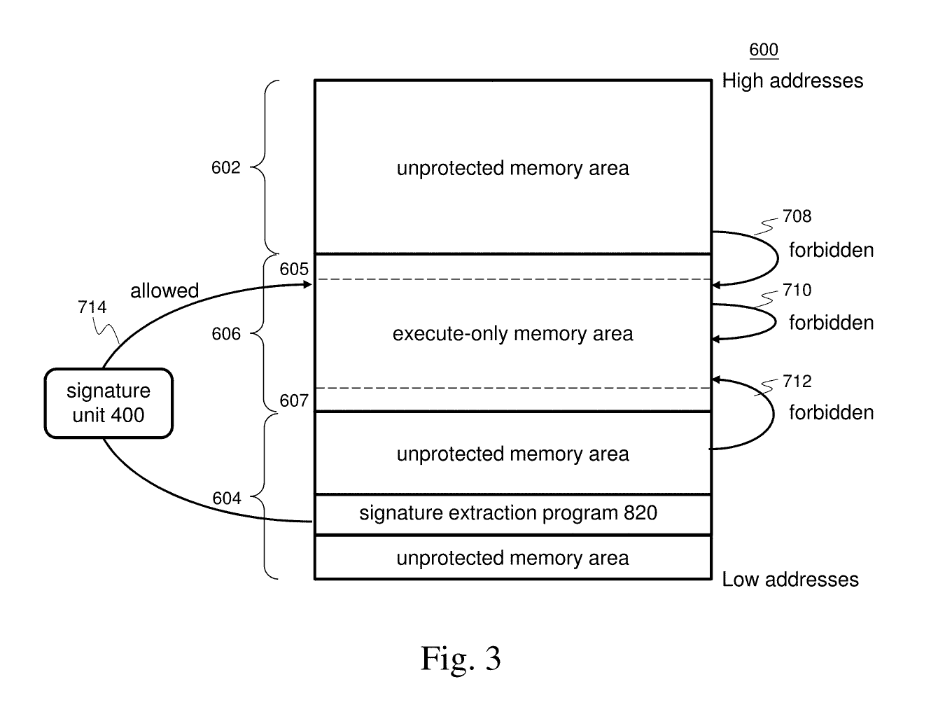

Access rights in various memory areas of the memory unit 200 can be assigned by hardware logic or in a boot sequence. The whole or a portion of the memory unit 200 can be configured into a protected memory area by limiting the read, write, and/or execute right of themselves. For example, a read, a write, and/or an execute-only attribute are/is assigned to portions of the memory unit 200. Based on the assigned attributes, the SoC 10 can determine whether a memory access from the processor 100 to a specified memory location is allowed. If an execute-only access right is assigned to a memory area, then read and write accesses from the processor 100 to the content of the execute-only memory area are blocked. In other words, an execute-only attribute of the protected memory area can be used to forbid any non-instruction fetch access (read access or write access) from the processor 100. Therefore, instructions of a protected software program can be stored in the execute-only memory area to forbid any non-instruction fetch access from the processor 100. The SoC 10 may be given a memory map describing access rights of various memory areas in the memory unit 200. There might be multiple program segments stored in different protected memory areas described by the memory map, and each program segment may comprise multiple instructions. The memory map is described in FIG. 3.

The processor 100 (e.g., a von Neumann architecture processor) provides a memory space for both instructions and data, and may not feature execute-only access rights for the memory locations of the memory unit 200. Using the control unit 110 and the MPU 300, one or more execute-only memory areas can be programmed or fixed in a memory map corresponding to the memory unit 200. The control unit 110 may execute instructions in several sequential steps. These steps contain instruction fetch access 510 and probably data access 520 (memory read or write operations). The MPU 300 receives the instruction fetch access 510 or the data access 520, and may generate an exception signal 530 or an interrupt to abort the current instruction while the access is denied. The MPU 300 includes a protected address register(s) 310 and logic circuit(s) 320. The protected address register(s) 310 is used to store the information of the protected memory areas, and the logic circuit(s) 320 is responsible for determining whether a memory access is allowed. One protected memory area can be defined using the information of a start address and a length with an attribute corresponding to that memory area, and several protected memory areas can be specified using multiple pairs of start addresses and lengths. Based on the access type (i.e., instruction fetch access or data access) and the information of the protected address register(s) 310, the MPU 300 can generate an exception signal 530 to abort memory access to the protected memory areas. For example, if a protected memory area is attributed as an execute-only memory area, only instruction fetch access 510 from the processor 100 to that memory area is allowed. Namely, the MPU 300 can distinguish instruction fetch access from other type access of the memory unit 200. In another implementation, protected memory area may be defined by a memory range as a pair of start and end addresses. The SoC 10 may further contain other co-processor(s) or I/O device(s) 150 that can access the memory unit 200. The MPU 300 manages the access of the memory unit 200 from the co-processor(s) or I/O device(s) 150 in the same manner as the access from the processor 100. In other words, the memory access from all devices (the processor 100, the co-processor or other I/O devices 150) except the memory signature unit 400 is restricted by the MPU 300. From the description above, the MPU 300 may manage access to the memory unit 200 from the processor 100 according to the protected address register 310 thereof.

Because that only instruction fetch access is allowed for an execute-only memory area (any other access, e.g., read and write access, are forbidden), only instructions should be stored therein. The memory unit 200 may be a non-volatile memory (e.g., NAND flash memory, which is erased and written by blocks) with protected instructions stored in the execute-only memory area. The protected instructions in the protected memory areas may be erased or renewed during an update process. During an erasing process, all of the memory array belonging to the protected memory area should be filled with the same value (e.g., all bit values are set to “0” or “1”), and then the protected attribute of the protected memory area is removed. After the erasing process, the renewed protected instructions may be written into a memory area. If needed, that memory area is set to an execute-only memory area to protect the instructions from piracy or been tampered. The memory signature unit 400 is used to verify the protected instructions after the memory area is set as execute-only memory. The memory signature unit 400 may be used to verify the validity of the protected instructions whenever verification is needed.

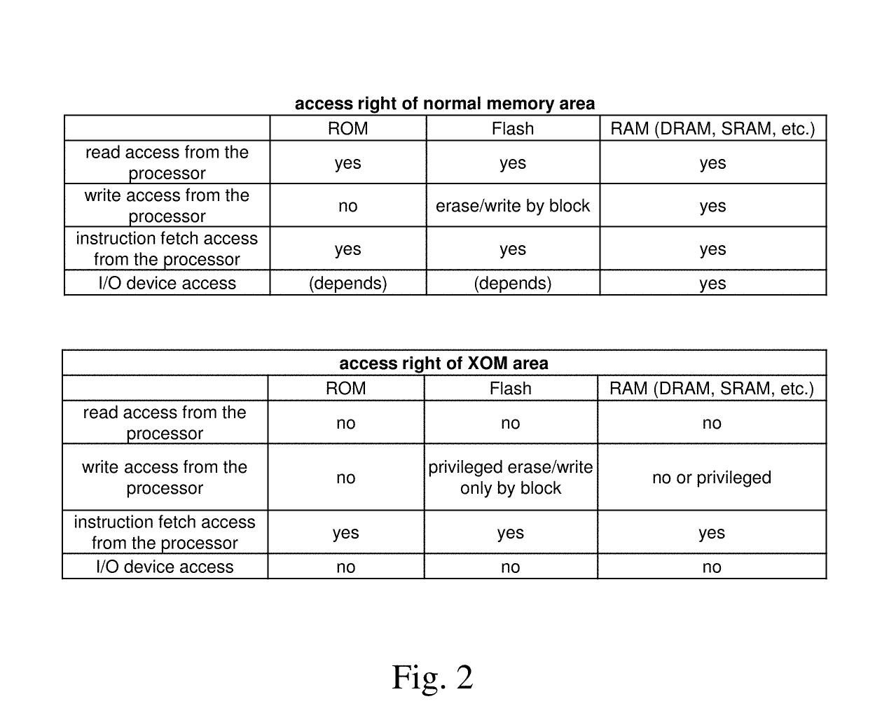

The execute-only attribute may also be applied to various types of memory unit 200, e.g., ROM, DRAM, or SRAM. FIG. 2 shows the access right of a normal memory area and an execute-only memory (XOM) area of the present invention. The list of access right of normal memory area shows access right is determined by the hardware nature (e.g., ROM, RAM, or Flash). For example, the program and/or data stored in a ROM during a manufacturing process cannot be changed (written) later. Without the filter of the MPU, both read and instruction fetch access from the processor are allowed. The access right of I/O devices or other co-processors may vary depending on the design of the system. In another example, when the memory unit 200 is a Flash memory that is rewritable, it is erased in blocks and then new content is written therein. If the memory unit is a Random Access Memory (RAM), all type of access may be allowed. The list of access right of execute-only memory (XOM) area shows access right varies by both the hardware nature and the associated attributes stored in the MPU. For example, for an execute-only memory area in a ROM, only instruction fetch access form the processor is allowed. For an execute-only memory area in a Flash memory, instruction fetch access form the processor is allowed, read access from the processor is forbidden. The write access of that memory area is limited under privilege control. Since the purpose of execute-only memory (XOM) in the present invention is to protect instruction of a software program, for which alternation of the software program is in general not desirable. However, for the cases that the software program needs to be loaded to the memory unit or updated, the writing of the memory should be controlled under special permission from the operating system or user with privilege. If the memory unit is a Random Access Memory (RAM), read access from the processor and access from I/O devices are forbidden, but the instruction fetch access from the processor is allowed. The write access of execute-only memory (XOM) area is forbidden or limited under privilege control according to the design of the system.

The memory signature unit 400 is connected to the processor 100 and the memory unit 200. It is connected to the memory unit 200 using a Direct Memory Access (DMA) channel 540 that is not regulated by the MPU 300. The DMA channel 540 can be implemented using a DMA controller. The processor 100 sends a signature extraction signal 550 to the memory signature unit 400 when a signature extraction program 820 is executed by the processor 100. The signature extraction program 820 may specify the start address and the length of a specified memory area via the signature extraction signal 550, and may optionally provide an activation signal to the memory signature unit 400 via the signature extraction signal 550. In some implementation, the range of the specified memory area may be a pair of start and end addresses thereof. The memory signature unit 400 then sends sequential read accesses via the DMA channel 540 according to the specified address range. The content (e.g., protected software program) stored in the specified memory area will be sent back to the memory signature unit 400, regardless the specified memory range is attributed as execute-only or not. The memory signature unit 400 generates a signature value of the content stored in the specified memory area and stores the signature value in the read-only register 410. After that, the processor 100 may request that signature value from the memory signature unit 400 by reading the register 410. The DMA channel 540 that is not regulated by the MPU 300 can be used only by the memory signature unit 400. The signature value may be generated by applying a checksum or hash method to the content stored in the specified memory area. The signature value of the protected instructions may be compared with a predetermined signature data to verify its validity. The predetermined signature data may be stored in an unprotected memory area. The predetermined signature data, which is generated by applying the same checksum or hash method to the protected software program, may be provided by the developer of the protected software program.

Please refer to FIG. 3. FIG. 3 shows an example memory map having an execute-only memory area. A memory map 600 corresponding to the memory unit 200 includes two unprotected memory areas 602, 604 and an execute-only memory area 606. The memory map 600 may be hard-wired during the manufacturing process or loaded during a secure boot sequence which assigns the execute-only memory area 606 with a pair of start address and length, and an attribute of the protected address register(s) 310 of FIG. 1. The start address and length may be stored in a pair of base and limit registers of the protected address register(s) 310 respectively. Alternatively, an end memory address 605 and a start memory address 607 for the execute-only memory area may be assigned in the limit register and the base register, respectively. Arrows 708, 710, 712, and 714 represent different types of data access from different parts of the memory area to the execute-only memory area 606. The data accesses 708 and 712 are originated by a software program stored in the unprotected memory area 602, 604, respectively. The data access 710 is originated by a software program stored in the execute-only memory area 606. The data access 708 may be caused by an instruction fetched from the unprotected memory area 602 to read a memory location in the execute-only memory area 606. The data access 710 may be caused by an instruction fetched from the execute-only memory area 606 to read a memory location in the execute-only memory area 606. The data access 712 may be caused by an instruction fetched from the unprotected memory area 604 to read a memory location in the execute-only memory area 606. The data access 714 may be caused by a control program of the memory signature unit 400 (i.e., the signature extraction program 820) stored in the unprotected memory area 604. The signature extraction program 820 may specify the start address and length of a specified memory area and then (use an activation signal to) invoke the memory signature unit 400 to access the execute-only memory area 606 and to generate the signature value thereof. As shown in FIG. 3, the data accesses 708, 710, and 712 are forbidden, while the data access 714 is allowed. The MPU 300 may send an exception signal 530 to the processor 100 to block the data access of the execute-only memory area 606; on the contrary, the instruction fetch access is allowed. The signature extraction program 820 may also be stored in other memory units in the SoC 10, such as a boot ROM or an OTP (One-Time Programmed) memory.

Hardware crypto accelerator circuits are common in low-cost microprocessors that are used in security applications. The memory signature unit 400 that works with hardware crypto accelerator circuits may significantly reduce the complexity of the MPU 300 while dealing with an N-stage instruction pipeline of a processor (described in the prior art of U.S. Pat. No. 8,327,100). The memory signature unit 400 is a hardware circuit so that it does not suffer from a malware disguised as a renewed instruction. For example, the malware disguised as a renewed instruction in a SoC without the memory signature unit 400 may always send a valid signature value to any instruction that requests verification of the content stored in the execute-only memory area.

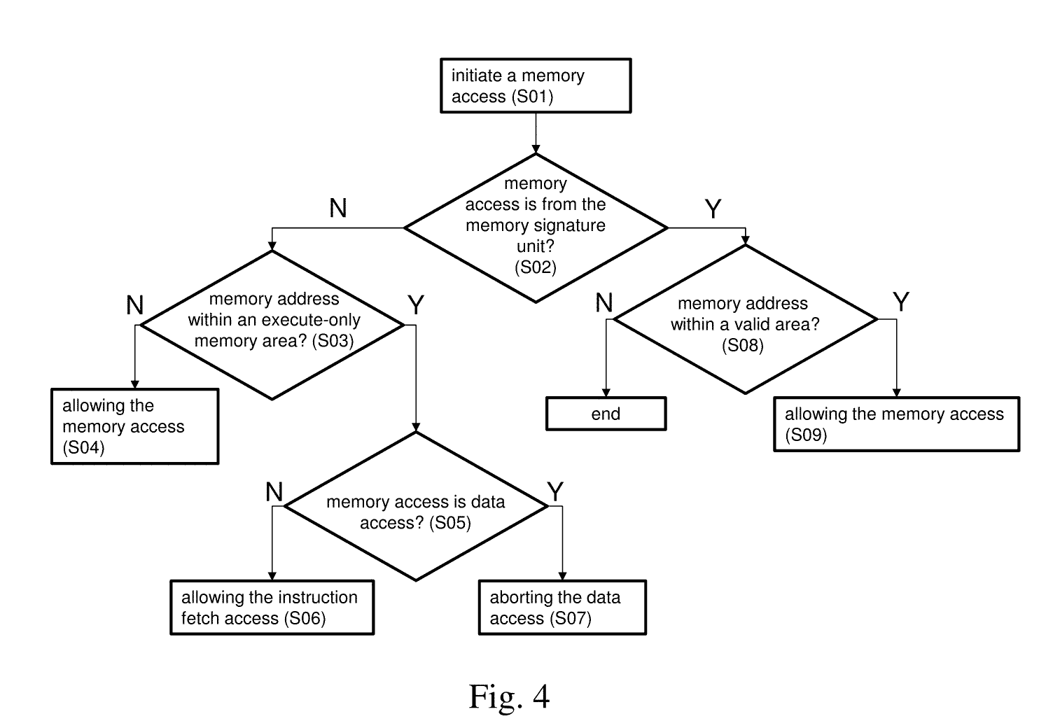

Please refer to FIG. 4. FIG. 4 shows a flowchart of an example method to allow or forbid access to the memory unit having execute-only memory areas. The method begins that a memory access is initiated (S01). Since the control unit 110 invokes the memory signature unit 400 by sending the signature extraction signal 550 thereto during the execution of the signature extraction program 820 or sends memory access signal (i.e., instruction fetch access 510 or data access 520) to the MPU 300, then, a second step is to determine if a memory access is from the memory signature unit 400 (S02). If the MPU 300 receives the memory access signal, then check whether the memory address to be accessed is within an execute-only memory area (S03). Allow memory access if the memory address to be accessed is not within an execute-only memory area (S04); otherwise, check if the memory access is data access by the MPU 300 (505). If the memory access is an instruction fetch access, the memory access is allowed (S06). If the memory access is data access, the memory access is aborted (S07). If the memory signature unit 400 is invoked and sending memory read requests, check whether the memory address to be accessed is within a valid memory area by the memory signature unit 400 (S08) to prevent any misuse of the memory signature unit 400. The memory access is allowed (S09) while the valid area check is passed; otherwise, the process stops. The valid check may be a bounds checking and may be skipped to increase the performance of the memory signature unit 400. A method for the SoC to verify the validity of the protected software program stored in the execute-only memory areas of the memory unit 200 includes the following steps when the memory signature unit 400 is used to access the memory unit after step S09. First, a signature value of a specified memory area is generated and stored in the read-only register 410 by the memory signature unit 400. Then, the signature value stored in the memory signature unit 400 is compared with a predetermined signature data to verify the validity of the software program by the control unit 110.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A secure system on chip that prevents a software program from being tampered, rehosted, and pirated, comprising:
a processor;
a memory unit, wherein at least a portion thereof is configured into a protected memory area by limiting the read, write, and/or execute right thereof, and instructions of the software program to be protected are stored in a protected memory area defined as execute-only to forbid any non-instruction fetch access from the processor;
a memory protection unit (MPU), connected between the processor and the memory unit, for managing access of the memory unit from the processor, wherein the MPU distinguishes instruction fetch access from other type of access to the memory unit; and
a memory signature unit, connected to the processor and the memory unit, having a read-only register to store a memory signature extracted from contents stored in a specified memory area of the memory unit by a signature extraction signal received from the processor, wherein the memory signature unit is connected to the memory unit via a Direct Memory Access (DMA) channel, and the access to memory via the DMA channel is not regulated by the MPU;
wherein a signature value stored in the memory signature unit is compared with a predetermined signature data to verify the validity of the protected software program.

2. The secure system on chip according to claim 1, wherein a signature value of the memory signature is a hash value or a checksum of the contents stored in the specified memory area of the memory unit.

3. The secure system on chip according to claim 1, wherein the protected memory area is defined according to a pair of start address and length, or a memory range of the protected memory area.

4. The secure system on chip according to claim 3, wherein the memory protection unit manages access to the memory unit from the processor according to the range of the protected memory area and the attribute thereof.

5. The secure system on chip according to claim 1, wherein multiple program segments are stored in different protected memory areas of the memory unit, while each program segment comprises multiple instructions.

6. The secure system on chip according to claim 1, wherein the secure system on chip comprises other co-processor(s) or I/O device(s), and accesses of the memory unit from other co-processor(s) or I/O device(s) are managed by the MPU.

7. The secure system on chip according to claim 1, wherein the signature extraction signal comprises a pair of start address and length, or a pair of start and end addresses of the memory area, and optionally an activation signal to invoke the memory signature unit.

8. A method to manage the access of the memory unit of the secure system on chip according to claim 1, comprising the steps of:
a) initiating a memory access;
b) determining whether a memory access is from the memory signature unit;
c) if an answer of step b) is no, allowing memory access if the memory address to be accessed is not within an execute-only memory area, allowing instruction fetch access if the memory address to be accessed is within an execute-only memory area, or aborting memory access if the memory address to be accessed is within an execute-only memory area and memory access is data access; and
d) if an answer of step b) is yes, the memory access is allowed when the memory address to be accessed is within a valid area.

9. A method to verify the validity of the protected software program stored in the execute-only memory areas of the memory unit in the secure system on chip according to claim 1, comprising the steps of:
a) generating a signature value of a specified memory area by the memory signature unit, storing the signature value into the read-only register in the memory signature unit; and
b) comparing the signature value stored in the memory signature unit with a predetermined signature data.
